(19) United States
(12) Patent Application Publication
(10) Pub. No.: US 2023/0051565 A1
(43) Pub. Date: Feb. 16, 2023

(54) HARD EXAMPLE MINING FOR TRAINING A NEURAL NETWORK

(71) Applicant: Waymo LLC, Mountain View, CA (US)

(72) Inventors: Dillon Cower, Woodinville, WA (US); Timothy Yang, Redwood City, CA (US); Kunlong Gu, Belmont, CA (US); Marshall Friend Tappen, Bainbridge Island, WA (US)

(21) Appl. No.: 17/398,436

(22) Filed: Aug. 10, 2021

(51) Int. Cl. G06K 9/62; G06N 3/04; G06K 9/00

(52) U.S. Cl. CPC G06K 9/6262; G06N 3/0454; G06K 9/00791; G06K 9/628

(57) ABSTRACT

A method for determining hard example sensor data inputs for training a task neural network is described. The task neural network is configured to receive a sensor data input and to generate a respective output for the sensor data input to perform a machine learning task. The method includes: receiving one or more sensor data inputs depicting a same scene of an environment, wherein the one or more sensor data inputs are taken during a predetermined time period; generating a plurality of predictions about a characteristic of an object of the scene; determining a level of inconsistency between the plurality of predictions; determining that the level of inconsistency exceeds a threshold level; and in response to the determining that the level of inconsistency exceeds a threshold level, determining that the one or more sensor data inputs comprise a hard example sensor data input.

### BACKGROUND

This specification relates to determining hard example sensor data inputs for training a neural network to perform a machine learning task.

Performing the machine learning task, e.g., an image classification task or an object detection task, can assist in motion planning, e.g., by an autonomous vehicle.

Autonomous vehicles include self-driving cars, boats, and aircraft. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an on-board camera is likely to be an image of a nearby car. Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer.

Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

An architecture of a neural network specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the neural network thus involves continually performing a forward pass on the input, computing gradient values, and updating the current values for the set of parameters for each layer using the computed gradient values, e.g., using gradient descent. Once a neural network is trained, the final set of parameter values can be used to make predictions in a production system.

### SUMMARY

This specification describes a system implemented as computer programs on one or more computers in one or more locations that determines hard example sensor data inputs (which can also be referred to as “hard examples” for simplicity) for training a task neural network. The task neural network is configured to process a sensor data input to generate a respective output for the sensor data input to perform a machine learning task. The sensor data input can be, for example, an image, Lidar data (e.g., point clouds), or an input that is a combination of an image and Lidar data.

The subject matter described in this specification can be implemented in particular embodiments so as to realize one or more of the following advantages.

Hard examples refer to examples in a training dataset that are being misclassified or poorly-predicted by a current version of a machine learning model (e.g., a trained prediction model) or by a current version of an overall system that includes multiple machine learning models. For example, given that an image depicts a scene having a pedestrian but the current version of the machine learning model or of the overall system mistakenly classifies the pedestrian as a cyclist, then the image can be referred to as a “hard example” (or a “hard example image”). Hard examples are often sparse in training data and are expensive to obtain using conventional data mining methods (e.g., human labeling method).

The described techniques can automatically mine hard examples (e.g., from a large corpus of data) by determining a level of inconsistency between multiple predictions about the same characteristic of an object in a scene captured in one or more input images. If the level of inconsistency exceeds a threshold level, then the one or more input images are determined as including a hard example. Thus, compared to existing hard example mining methods, the described techniques can collect hard examples faster and in a more cost effective way, thus reducing the time and costs associated with training a neural network. The collected hard examples can be used to train a neural network, allowing the neural network to have better performance (e.g., higher accuracy) on sensor data processing tasks such as image classification, semantic segmentation or object detection tasks than existing neural networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system for determining hard example sensor data inputs for training a task neural network.

FIG. 2 illustrates an example process for determining a level of inconsistency between a plurality of predictions using a temporal inconsistency method.

FIG. 3 illustrates an example process for determining a level of inconsistency between a plurality of predictions using an ensemble inconsistency method.

FIG. 4 is a flow diagram of an example process for determining hard example sensor data inputs for training a task neural network.

Like reference numbers and designations in the various drawings indicate like elements.

### DETAILED DESCRIPTION

This specification describes a system implemented as computer programs on one or more computers in one or more locations that determines hard example sensor data inputs for training a task neural network on a machine learning task.

The task neural network can be trained to perform any kind of machine learning task, i.e., can be configured to receive any kind of sensor data input and to generate any kind of score, classification, or regression output based on the input. The sensor data input can be, for example, an image, Lidar data (e.g., point clouds), or an input that is a combination of an image and Lidar data.

In some cases, the task neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

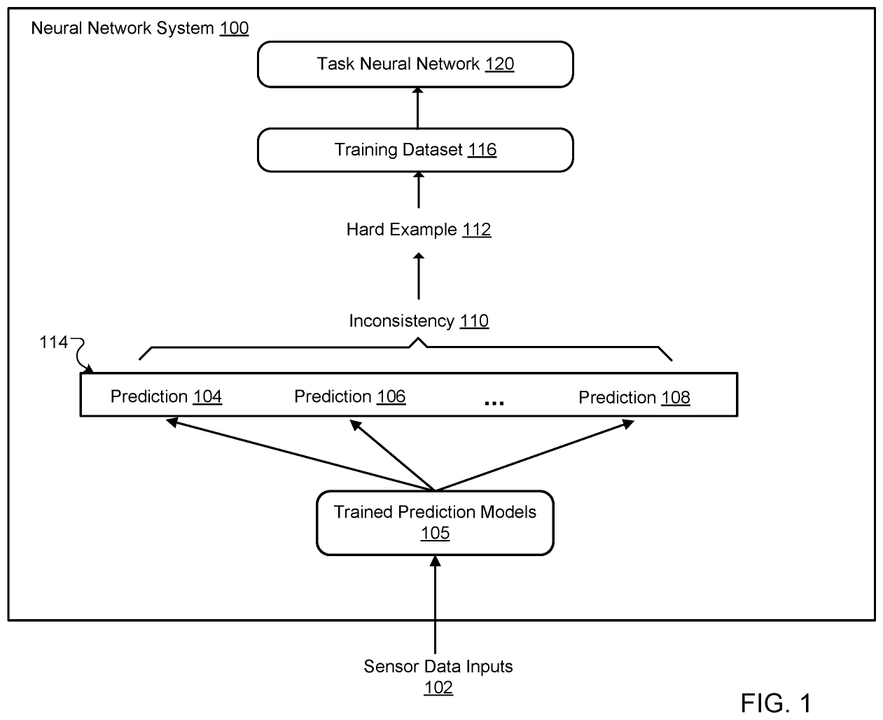

FIG. 1 illustrates an example neural network system 100 that determines hard example sensor data inputs for training a task neural network 120 on a machine learning task. The neural network system 100 is an example of a system implemented as computer programs on one or more computers in one or more locations, in which the systems, components, and techniques described below can be implemented. The task neural network is configured to process a sensor data input to generate a respective output for the sensor data input to perform the machine learning task.

The system 100 obtains one or more sensor data inputs 102 depicting the same scene in an environment. In some implementations, the system 100 obtains the inputs 102 by sampling the inputs 102 from log data. In some other implementations, the system 100 receives the inputs 102 from another system. The one or more sensor data inputs 102 can be, for example, a sequence of frames of a video being captured by one or more sensors of a vehicle during a predetermined time period (e.g., 3 seconds, 5 seconds, 10 seconds or 18 seconds). The vehicle can be, for example, an autonomous vehicle or a semi-autonomous vehicle.

The system 100 processes the one or more sensor data inputs using one or more trained prediction models 105 to generate a plurality of predictions (including, e.g., prediction 104, 106, and 108) about a characteristic of an object of the scene. The one or more trained prediction models are configured process a sensor data input to generate a respective output (i.e., a prediction) for the sensor data input to perform the machine learning task. The one or more trained prediction models can be trained on the machine learning task using training data sampled from the log data, or using a different set of training data. In some implementations, the one or more trained prediction models are the same as the task neural network 120, i.e., the one or more trained prediction models have the same network architecture as the task neural network 120 and have the current network parameters of the task neural network 120. In some other implementations, the one or more trained prediction models are different from the task neural network 120.

The characteristic of the object can be, for example, an object class such as a pedestrian, a cyclist, a car, a truck, a motorbike, a bicycle, a wheelchair, an animal, or an unmovable object.

As another example, the characteristic of the object can be a heading direction or other property of a bounding box of the object. The bounding box is a virtual rectangle with vertical and horizontal sides surrounding the object. For example, if the object is a wheelchair, then the characteristic of the object can be a heading direction of a bounding box surrounding the wheelchair.

As another example, the characteristic of the object can be a size of the object which is represented by at least one of a width or a length of the object.

The system 100 determines a level of inconsistency 110 between the plurality of predictions 114 and whether the level of inconsistency 110 exceeds a threshold level or not. If the level of inconsistency 110 exceeds a threshold level, the system 100 determines that the one or more sensor data inputs are a hard example sensor data input 112.

In particular, the system 100 can determine the level of inconsistency between the plurality of predictions 114 using a hard example mining method such as a temporal inconsistency method or an ensemble inconsistency method.

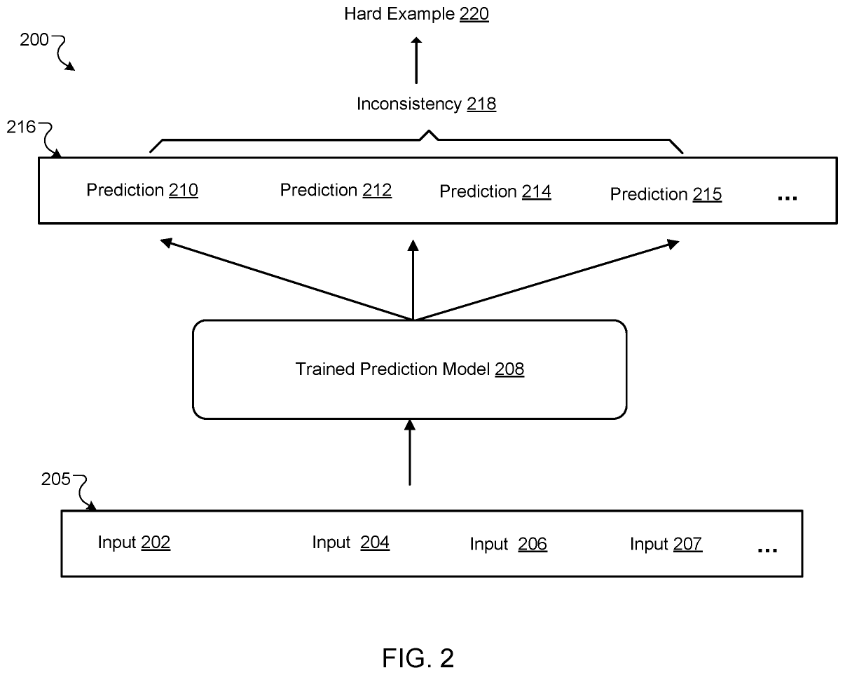

FIG. 2 illustrates an example process 200 which can be performed by the system 100 for determining a level of inconsistency between a plurality of predictions using the temporal inconsistency method. When the temporal inconsistency method is used, the system 100 generates the plurality of predictions 216 (including, for example, prediction 210, 212, 214, 215, etc.) about the characteristic of the object of the scene by using a single trained prediction model 208 (e.g., a single classifier). In some implementations, the classifier neural network 208 is configured to generate a respective prediction for each of the plurality of sensor data inputs 205 (including, for example, sensor data inputs 202, 204, 206, 207, etc.). In some other implementations, the classifier neural network is configured to generate a prediction for every few images (for every two, three, or five sensor data inputs in the plurality of sensor data inputs 205). The plurality of sensor data inputs 205 are of the same scene but generated at different times. For example, the inputs 205 are images of the same scene but taken at different times.

Generally, the system 100 determines a level of inconsistency 218 by counting a number of times that the characteristic of the object changes or significantly changes in the predictions 114.

In some implementations, the characteristic of the object is an object class. The object class is one of a plurality of object classes. For example, the plurality of object classes may include, a pedestrian, a cyclist, a car, a truck, a motorbike, a bicycle, a wheelchair, an animal, and an unmovable object. As another example, the plurality of object classes may include binary object classes such as “detected” or “undetected” (e.g., whether a child is detected or undetected in a scene). The system 100 can determine a number of times that the object class of the object has changed in the plurality of predictions generated by the trained prediction model 208 during a predetermined time period. To generate a prediction of an object class of the object, the trained prediction model 208 generates a score distribution over the plurality of object classes. The model 208 can assign an object class to the object, e.g., by selecting an object class associated with a maximum score, or based on other criteria.

As an illustrative example, the prediction 210 predicts that the object is a pedestrian, the prediction 212 predicts that the object is an unmovable object, the prediction 214 predicts that the object is a cyclist, and prediction 215 predicts that the object is a pedestrian, then the number of times that the object class of the object has changed (or flipped) between a pedestrian, an unmovable object, and a cyclist in these predictions is 3. Assuming that the threshold number of times is 2, then the system 100 determines that the number of times that the object class has changed in the predictions 216 exceeds the threshold number of times (i.e., 3>2). Therefore, the system 100 determines that the sensor data inputs 205 includes a hard example 220, because it is hard for the trained prediction model 208 to generate a consistent prediction for the object in the scene captured in the sensor data inputs 205.

In some other implementations, the characteristic of the object can be a heading direction of a bounding box of the object in the scene. The bounding box is a virtual rectangle with vertical and horizontal sides surrounding the object. The object may be a moveable object such as a car, a truck, or a wheelchair.

In some cases, the trained prediction model 208 is configured to process each of the inputs 205 to generate a respective prediction that specifies a heading direction of the bounding box of the object. In some other cases, the trained prediction model 208 is configured to process every few inputs of the inputs 205 (e.g., every 2, 3, or 5 images) to generate a respective prediction that specifies a heading direction of the bounding box of the object.

The system 100 determines a number of times that the heading direction of the bounding box has changed more than a threshold angle in the plurality of predictions 216 generated by the trained prediction model 208. The threshold angle may be, for example, 75 degrees, 90 degrees or 120 degrees. If the number of times that the heading direction of the bounding box has changed more than the threshold angle in the plurality of predictions 216 exceeds a threshold number of times, then the system 100 determines that the sensor data inputs 205 includes a hard example 220.

In some other implementations, the characteristic of the object can be a size of the object which is represented by at least one of a width or a length of the object.

In some cases, the trained prediction model 208 is configured to process each of the inputs 205 to generate a respective prediction that specifies at least a width or a length of the object. In some other implementations, the trained prediction model 208 is configured to process every few inputs of the inputs 205 (e.g., every 2, 3, or 5 images) to generate a respective prediction that specifies at least a width or a length of the object.

The system 100 determines a level of inconsistency 218 between the plurality of predictions 216 by determining a number of times that at least one of a width or a length of the object has changed more than a threshold distance in the plurality of predictions 216. The threshold distance may be, for example, 0.5 meters, 0.7 meters, 0.8 meters, 1 meters, or 1.15 meters. If the number of times that at least one of a width or a length of the object has changed more than the threshold distance exceeds a threshold number of times, then the system 100 determines that the sensor data inputs 205 includes a hard example 220.

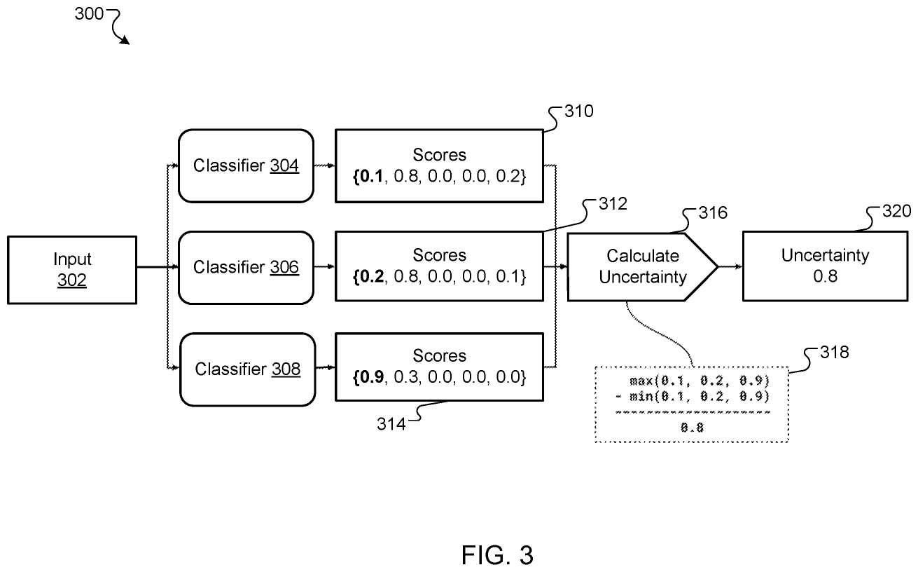

FIG. 3 illustrates an example process 300 which can be performed by the system 100 for determining a level of inconsistency between a plurality of predictions using the ensemble inconsistency method. When the ensemble inconsistency method is used, the system 100 generates the plurality of predictions 114 about the characteristic of the object of the scene by using an ensemble of multiple trained prediction models, e.g., an ensemble of classifier neural networks 304, 306, and 308. Each of the trained prediction models is configured to process an sensor data input to generate a respective prediction. In some implementations, the trained prediction models have a same network architecture but different network parameters because they have been trained using different training datasets.

The system 100 provides a particular input image 302 of the one or more sensor data inputs 102 to each of the multiple trained prediction models. Each of the trained prediction models is configured to process the particular input image 302 to generate a respective prediction. For example, trained prediction models 304, 306, and 308 generate predictions 310, 312, and 314, respectively.

The respective prediction may assigns a score to each object category of a set of object categories, with each score representing an estimated likelihood that the object of the scene depicted in the particular input image belonging to the respective object category.

For example, let {c₁,c₂,c₃,c₄,c₅} denote the plurality of object categories. The prediction 310 assigns a respective score to each object category as {0.1,0.8,0.0,0.0,0.2}. The prediction 312 assigns a respective score to each object category as {0.2,0.8,0.0,0.0,0.1}. The prediction 314 assigns a respective score to each object category as {0.9,0.3,0.0,0.0,0.2}.

The system 100 determines a level of inconsistency between the predictions generated by the trained prediction models by calculating (316) a level of uncertainty 320 based on the scores assigned to the set of object categories by the predictions 310, 312, and 314.

In some implementations, to calculate the level of uncertainty 320, for each of one or more object categories of the set of object categories, the system 100 determines a maximum score for the object category among the scores assigned to the object category by the plurality of predictions, determines a minimum score for the object category among the scores assigned to the object category by the plurality of predictions, and calculates a difference between the maximum score and the minimum score for the object category. For instance, as shown in FIG. 3 at 318, the difference between the maximum score and the minimum score for the object category c₁ is 0.8. That means, the level of uncertainty 320 (which is also the level of inconsistency) is 0.8. The system 100 then determines whether the level of uncertainty 320 exceeds a threshold level, and if so, the system 100 determines that the particular input image 302 is a hard example sensor data input. For example, in this case, the threshold level indicates that the difference should not exceed 0.5. The level of uncertainty 320, which is 0.8, already exceeds the threshold amount of difference, which is 0.5. Therefore, the system 100 determines that the particular input image 302 is a hard example sensor data input.

In some other implementations, the level of uncertainty 320 can be computed by using a different computation. For example, the system 100 determines, for each object category of the set of object categories, a variance of the scores assigned to the object category by the plurality of predictions. The system 100 then determines whether the variance of at least one object category exceeds a threshold variance. If the variance exceeds the threshold variance, then the system 100 determines that the particular input image 302 is a hard example image.

Referring back to FIG. 1, after determining the hard example 112, the system 100 adds the hard example 112 to a training dataset 116 for training the task neural network 120.

The system 100 can repeat the above hard example mining process to determine more hard example sensor data input like the input 112 and add them to the training dataset 116 until one or more criteria have been satisfied (e.g., until a predetermined number of hard example images has been obtained, until a memory limit for storing hard example images has been reached, or until a specified number of input examples have been checked for being hard examples). The system 100 uses the training dataset 116 to train the task neural network 120 on the machine learning task.

The system 100 can repeat the above process to determine more hard examples, add them to the training dataset 116 and then use the training dataset 116 to train/fine-tune the task neural network 120.

As mentioned above, when the trained prediction models 105 are the current version of the task neural network 120, the system 100 can use a current version of the trained task neural network 120 as the trained prediction models 105 to generate predictions 114 in order to determine hard examples. The system 100 then adds the hard examples to the training dataset 116 and use the updated dataset 116 to re-train the task neural network 120, which is then used as models 105 to generate predictions. The process can be repeated until, for example, a desired level of performance of the network 120 has been achieved or a computational budget for training the task neural network 120 has been reached.

In some cases, the system 100 trains multiple task neural networks 120 rather than a single one on the hard examples. For example, the system 100 can train both an object detection neural network that performs object detection, e.g., that generates bounding boxes that depict objects, and a classification neural network that classifies the detected objects.

Once the task neural network 120 (or the multiple task neural networks 120) has been fully trained, the task neural network(s) 120 can be, for example, deployed on an autonomous vehicle so that image classification or object detection may be performed by an on-board computer system of the autonomous vehicle as the autonomous vehicle navigates through the environment. In other words, the vehicle can use the trained neural network(s) 120 to perform image classification or object detection from images captured by one or more camera sensors of the autonomous vehicle. A planning system of the vehicle can use these predictions to make planning decisions to plan a future trajectory of the vehicle, e.g., by generating or modifying the future trajectory to avoid collisions with moving objects in the environment.

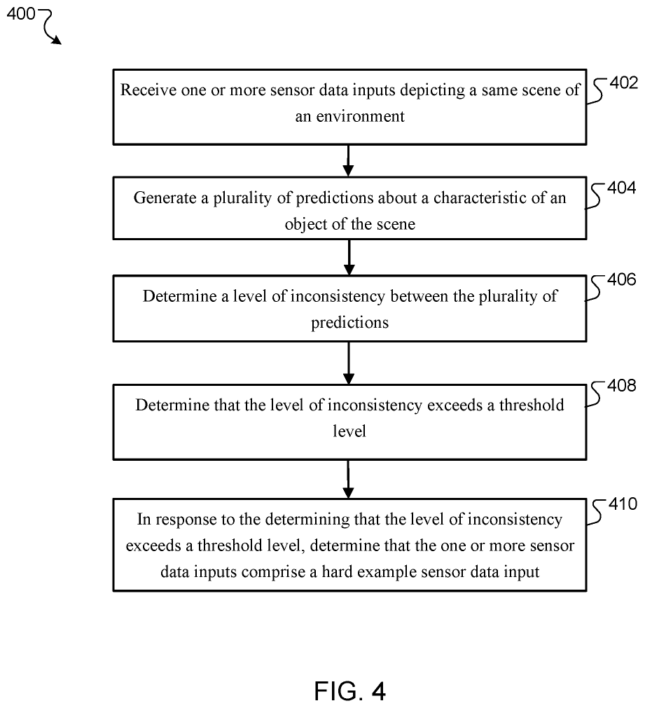

FIG. 4 is a flow diagram of an example process for determining hard example images for training a task neural network. For convenience, the process 400 will be described as being performed by a system of one or more computers located in one or more locations. For example, a neural network system, e.g., the neural network system 100 of FIG. 1, appropriately programmed in accordance with this specification, can perform the process 300.

The system receives one or more sensor data inputs depicting a same scene of an environment (step 402). The one or more sensor data inputs are taken during a predetermined time period. The one or more sensor data inputs may be captured by one or more camera sensors of an autonomous vehicle.

The system generates a plurality of predictions about a characteristic of an object of the scene (step 404).

In some first implementations, the one or more images include a plurality of images and the system generates, for each of the plurality of sensor data inputs, a respective prediction using a same classifier neural network.

In some second implementations, the system provides a particular input image of the one or more sensor data inputs to a plurality of trained prediction models. Each of the trained prediction models is configured to process the particular input image to generate a respective prediction. The plurality of trained prediction models may have a same network architecture but with different network parameters. The plurality of trained prediction models may be trained using different training datasets.

The system determines a level of inconsistency between the plurality of predictions (step 406). The system then determines that the level of inconsistency exceeds a threshold level (step 408).

In particular, in the first implementations, the system determines a level of inconsistency by counting a number of times that the characteristic of the object changes or significantly changes in the predictions.

For example, the characteristic of the object is an object class such as a pedestrian, a cyclist, a car, a truck, a motorbike, a bicycle, a wheelchair, an animal, or an unmovable object. The system determines the level of inconsistency between the plurality of predictions by determining a number of times that the object class of the object has changed in the plurality of predictions. The system determines that the level of inconsistency exceeds a threshold level by determining that the number of times that the object class of the object has changed in the plurality of predictions exceeds a threshold number of times.

As another example, the characteristic of the object is a heading direction of a bounding box of the object. The bounding box is a rectangle with vertical and horizontal sides surrounding the object. The system determines the level of inconsistency between the plurality of predictions by determining a number of times that the heading direction of the bounding box has changed more than a threshold angle in the plurality of predictions. The system determines that the level of inconsistency exceeds a threshold level by determining that the number of times that the heading direction of the bounding box has changed more than the threshold angle in the plurality of predictions exceeds a threshold number of times. For example, the threshold angle is 90 degree.

As another example, the characteristic of the object is a size of the object, wherein the size of the object includes at least one of a width or a length of the object. The system determines a level of inconsistency between the plurality of predictions by determining a number of times that at least one of a width or a length of the object has changed more than a threshold distance in the plurality of predictions. The system determining that the level of inconsistency exceeds a threshold level by determining that the number of times that at least one of a width or a length of the object has changed more than the threshold distance in the plurality of predictions exceeds a threshold number of times. The threshold distance, can be, for example, 1 meter.

In the second implementations where the plurality of predictions are generated by multiple trained prediction models, each classifier neural network generates a respective prediction that assigns a score to each object category of a set of object categories, with each score representing an estimated likelihood that the object of the scene depicted in the particular input image belonging to the respective object category.

The system determines a level of inconsistency between the plurality of predictions by, for each object category of the set of object categories, determining a maximum score for the object category among the scores assigned to the object category by the plurality of predictions, determining a minimum score for the object category among the scores assigned to the object category by the plurality of predictions, and calculating a difference between the maximum score and the minimum score for the object category. The system determines that the level of inconsistency exceeds a threshold level by determining that the difference determined for at least one object category exceeds a threshold amount of difference.

In response to the determining that the level of inconsistency exceeds a threshold level, the system determines that the one or more sensor data inputs comprise a hard example image (step 410).

In particular, as described above, in the first implementations, the system determines that the plurality of sensor data inputs include a hard example image if the level of inconsistency exceeds a threshold level. In the second implementations, the system determines that the particular input image is the hard example image if the level of inconsistency exceeds a threshold level.

The system can use the one or more sensor data inputs including the hard example image to train the task neural network to improve performance of the task neural network on the machine learning task. The machine learning task can be, for example, an image classification task or an object detection task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method for determining hard example sensor data inputs for training a task neural network, wherein the task neural network is configured to receive a sensor data input and to generate a respective output for the sensor data input to perform a machine learning task, the method comprising:
receiving one or more sensor data inputs depicting a same scene of an environment, wherein the one or more sensor data inputs are taken during a predetermined time period;
generating a plurality of predictions about a characteristic of an object of the scene;
determining a level of inconsistency between the plurality of predictions;
determining that the level of inconsistency exceeds a threshold level; and
in response to the determining that the level of inconsistency exceeds a threshold level, determining that the one or more sensor data inputs comprise a hard example sensor data input.

2. The method of claim 1, wherein the one or more sensor data inputs include a plurality of sensor data inputs and wherein generating the plurality of predictions about the characteristic of the object of the scene includes:
for each of the plurality of sensor data inputs, generating a respective prediction using a same classifier neural network.

3. The method of claim 1, wherein the characteristic of the object is an object class.

4. The method of claim 3, the object class is one of a pedestrian, a cyclist, a car, a truck, a motorbike, a bicycle, a wheelchair, an animal, or an unmovable object.

5. The method of claim 3, wherein determining the level of inconsistency between the plurality of predictions comprises: determining a number of times that the object class of the object has changed in the plurality of predictions, and
wherein determining that the level of inconsistency exceeds a threshold level comprises: determining that the number of times that the object class of the object has changed in the plurality of predictions exceeds a threshold number of times.

6. The method of claim 1, wherein the characteristic of the object is a heading direction of a bounding box of the object, wherein the bounding box is a rectangle with vertical and horizontal sides surrounding the object.

7. The method of claim 6, wherein determining the level of inconsistency between the plurality of predictions comprises: determining a number of times that the heading direction of the bounding box has changed more than a threshold angle in the plurality of predictions, and
wherein determining that the level of inconsistency exceeds a threshold level comprises: determining that the number of times that the heading direction of the bounding box has changed more than the threshold angle in the plurality of predictions exceeds a threshold number of times.

8. The method of claim 7, wherein the threshold angle is 90 degree.

9. The method of claim 1, wherein the characteristic of the object is a size of the object, wherein the size of the object includes at least one of a width or a length of the object.

10. The method of claim 9, wherein determining the level of inconsistency between the plurality of predictions comprises: determining a number of times that at least one of a width or a length of the object has changed more than a threshold distance in the plurality of predictions, and
wherein determining that the level of inconsistency exceeds a threshold level comprises: determining that the number of times that at least one of a width or a length of the object has changed more than the threshold distance in the plurality of predictions exceeds a threshold number of times.

11. The method of claim 10, wherein the threshold distance is 1 meter.

12. The method of claim 1, wherein the one or more sensor data inputs are captured by one or more camera sensors of an autonomous vehicle.

13. The method of claim 1, wherein generating the plurality of predictions about the characteristic of the object of the scene includes:
providing a particular sensor data input of the one or more sensor data inputs to a plurality of trained prediction models,
wherein each of the plurality of trained prediction models is configured to process the particular sensor data input to generate a respective prediction.

14. The method of claim 13, wherein the respective prediction assigns a score to each object category of a set of object categories, with each score representing an estimated likelihood that the object of the scene depicted in the particular sensor data input belonging to the respective object category.

15. The method of claim 13, wherein the plurality of trained prediction models have a same network architecture but with different network parameters.

16. The method of claim 13, wherein the plurality of trained prediction models have been trained using different training datasets.

17. The method of claim 14, wherein determining the level of inconsistency between the plurality of predictions comprises:
for each object category of the set of object categories:
determining a maximum score for the object category among the scores assigned to the object category by the plurality of predictions,
determining a minimum score for the object category among the scores assigned to the object category by the plurality of predictions, and
calculating a difference between the maximum score and the minimum score for the object category; and
wherein determining that the level of inconsistency exceeds a threshold level comprises: determining that the difference determined for at least one object category exceeds a threshold amount of difference; and
wherein determining that the one or more sensor data inputs comprise a hard example sensor data input comprises: determining that the particular sensor data input is the hard example sensor data input.

18. The method of claim 14, wherein determining the level of inconsistency between the plurality of predictions comprises:
for each object category of the set of object categories:
determining a variance of the scores assigned to the object category by the plurality of predictions, and
wherein determining that the level of inconsistency exceeds a threshold level comprises: determining that the variance of at least one object category exceeds a threshold variance; and
wherein determining that the one or more sensor data inputs comprise a hard example sensor data input comprises: determining that the particular sensor data input is the hard example sensor data input.

19. The method of claim 1, further comprising using the one or more sensor data inputs comprising the hard example sensor data input to train the task neural network to improve performance of the task neural network on the machine learning task.

20. The method of claim 1, wherein the machine learning task is one of an image classification task or an object detection task.

21. One or more non-transitory computer storage media encoded with instructions that, when executed by one or more computers, cause the one or more computers to perform operations for determining hard example sensor data inputs for training a task neural network, wherein the task neural network is configured to receive a sensor data input and to generate a respective output for the sensor data input to perform a machine learning task, the operations comprising:
receiving one or more sensor data inputs depicting a same scene of an environment, wherein the one or more sensor data inputs are taken during a predetermined time period;
generating a plurality of predictions about a characteristic of an object of the scene;
determining a level of inconsistency between the plurality of predictions;
determining that the level of inconsistency exceeds a threshold level; and
in response to the determining that the level of inconsistency exceeds a threshold level, determining that the one or more sensor data inputs comprise a hard example sensor data input.

22. A system comprising one or more computers and one or more non-transitory computer storage media encoded with instructions that, when executed by the one or more computers, cause the one or more computers to perform operations for determining hard example sensor data inputs for training a task neural network, wherein the task neural network is configured to receive a sensor data input and to generate a respective output for the sensor data input to perform a machine learning task, the operations comprising:
receiving one or more sensor data inputs depicting a same scene of an environment, wherein the one or more sensor data inputs are taken during a predetermined time period;
generating a plurality of predictions about a characteristic of an object of the scene;
determining a level of inconsistency between the plurality of predictions;
determining that the level of inconsistency exceeds a threshold level; and
in response to the determining that the level of inconsistency exceeds a threshold level, determining that the one or more sensor data inputs comprise a hard example sensor data input.
